(19) United States
(12) Patent Application Publication
(10) Pub. No.: US 2026/0051470 A1
(43) Pub. Date: Feb. 19, 2026

(54) Apparatus and Method for Manufacturing Electrode of Secondary Battery

(71) Applicant: SK On Co., Ltd., Seoul (KR)

(72) Inventors: Cheol Hong Kim, Daejeon (KR); Min Gu Kang, Daejeon (KR); Jae Youn Kim, Daejeon (KR); Jeong Won Wang, Daejeon (KR)

(21) Appl. No.: 19/261,109

(22) Filed: Jul. 7, 2025

(30) Foreign Application Priority Data
Aug. 16, 2024 (KR) 10-2024-0109924

(51) Int. Cl. H01M 4/04; B05C 11/02; B05C 13/02

(52) U.S. Cl. CPC H01M 4/0404; B05C 11/02; B05C 13/02

(57) ABSTRACT

An apparatus and a method for manufacturing an electrode of a secondary battery. The apparatus includes a conveyor configured to transport a substrate in a travel direction, a coating machine configured to coat the substrate transported in the travel direction by applying a slurry onto the substrate, a measurement device configured to repeatedly measure a slurry application amount while reciprocating in a width direction of the substrate in a state where the substrate is transported in the travel direction, and a controller configured to receive the slurry application amount repeatedly measured from the measurement device, calculate an average of the slurry application amount for a predetermined travel distance of the substrate, and control the coating machine to increase or decrease the slurry application amount within a predetermined control range when the calculated average is outside a specific management range.

### CROSS REFERENCE TO RELATED APPLICATION

This application claims priority to Korean Patent Application No. 10-2024-0109924 filed Aug. 16, 2024, the disclosure of which is hereby incorporated by reference in its entirety.

### BACKGROUND

### Technical Field

The present disclosure relates to an apparatus and method for manufacturing an electrode of a secondary battery.

### Technical Considerations

Secondary batteries are rechargeable batteries that are widely used in portable devices as well as electric vehicles, hybrid vehicles, and energy storage devices.

The manufacturing of secondary batteries includes an electrode manufacturing process, and the electrode manufacturing process involves mixing active materials, conductive materials, and binders to create a positive or negative electrode.

The electrode manufacturing process includes: a mixing process for mixing an active material, a conductive material, and a binder to produce a slurry; a coating process for coating the slurry on a metal substrate like aluminum or copper; and a drying process for drying an electrode in a state where the slurry is coated on the metal substrate.

In particular, in the coating process, when applying a slurry to a metal substrate, the slurry needs to be applied in a uniform amount to prevent voltage imbalance between the secondary batteries being manufactured.

### SUMMARY

According to a non-limiting aspect of the present disclosure, provided is an apparatus and method for manufacturing an electrode of a secondary battery capable of uniformly applying a slurry in the longitudinal direction to an electrode substrate.

The apparatus and method for manufacturing an electrode of a secondary battery according to a non-limiting aspect of the present disclosure can be widely applied to green technology fields such as electric vehicles, battery charging stations, and solar and wind power generation using batteries.

The apparatus and method for manufacturing an electrode of a secondary battery according to a non-limiting aspect of the present disclosure can be applied to a manufacturing process of secondary batteries used in eco-friendly electric vehicles, hybrid vehicles, etc., which are crucial in combating climate change by reducing air pollution and greenhouse gas emissions.

An apparatus for manufacturing an electrode of a secondary battery according to a non-limiting aspect of the present disclosure may include: a conveyor configured to transport a substrate in a travel direction; a coating machine configured to coat the substrate transported in the travel direction by applying a slurry onto the substrate; a measurement device configured to repeatedly measure a slurry application amount while reciprocating in a width direction of the substrate in a state where the substrate is transported in the travel direction; and a controller configured to receive the slurry application amount repeatedly measured from the measurement device, calculate an average of the slurry application amount for a predetermined travel distance of the substrate, and control the coating machine to increase or decrease the slurry application amount within a predetermined control range when the calculated average is outside a specific management range.

According to a non-limiting embodiment, the specific management range may be set in the controller and may be one area including an upper limit and a lower limit formed to maintain a center deviation within a range of ±0.05 mg/cm² to ±0.2 mg/cm².

According to a non-limiting embodiment, the controller may control the coating machine, and when the average of the slurry application amount is outside the specific management range, may increase or decrease the slurry application amount within a control range of a minimum of 0.005 mg/cm² to a maximum of 0.3 mg/cm².

According to a non-limiting embodiment, the apparatus may further include a dryer configured to dry the slurry coated on the substrate, wherein the controller may organize changes in the slurry application amount into a certain group, which is repeatedly measured by the measurement device while the measurement device reciprocates over the predetermined travel distance of the substrate from a point where the slurry is applied to the substrate by the coating machine to a point where the substrate passes through the dryer, and may calculate the average.

According to a non-limiting embodiment, the controller may display the specific management range as an upper limit and a lower limit on one area, and may display the average of the slurry application amount calculated over the predetermined travel distance of the substrate as continuous data on the area having the upper and lower limits after receiving the slurry application amount from the measurement device.

A method for manufacturing an electrode of a secondary battery according to a non-limiting aspect of the present disclosure may include: coating a substrate, by a coating machine, by applying a slurry onto the substrate being transported at a predetermined speed; repeatedly measuring, by a measurement device, a slurry application amount while the measurement device reciprocates in a width direction of the substrate in a state where the substrate is transported in a travel direction; calculating, by a controller, an average of the slurry application amount over a predetermined travel distance of the substrate by receiving the slurry application amount repeatedly measured from the measurement device; checking, by the controller, whether the calculated average of the slurry application amount is outside a specific management range; and controlling, by the controller, the coating machine to increase or decrease the slurry application amount when the average of the slurry application amount is outside the specific management range.

According to a non-limiting embodiment, the method may further include setting, before the coating of the substrate by applying the slurry onto the substrate, in the controller, the specific management range that serves as a standard for controlling an amount of slurry applied to the substrate, and a predetermined control range for controlling the slurry application amount when the slurry application amount exceeds the specific management range.

According to a non-limiting embodiment, the specific management range may be a range where upper and lower limits are designated on one area, with the upper and lower limits being set to form a center deviation within the range of ±0.05 mg/cm² to ±0.2 mg/cm², and the predetermined control range may be set to control the slurry application amount within a range of a minimum of 0.005 mg/cm² to a maximum of 0.3 mg/cm².

According to a non-limiting embodiment, in the controlling, by the controller, of the coating machine to increase or decrease the slurry application amount, the slurry application amount may be controlled within a control range of a minimum of 0.005 mg/cm² to a maximum of 0.3 mg/cm² so that the average of the slurry application amount converges within the specific management range.

According to a non-limiting embodiment, in the repeatedly measuring, by a measurement device, of the slurry application amount while the measurement device reciprocates in the width direction of the substrate in a state where the substrate is transported in the travel direction, with the measurement device positioned in front of an outlet of a dryer, the slurry application amount may be repeatedly measured over the predetermined travel distance of the substrate until a point at which the substrate passes through the dryer after the slurry is applied to the substrate by the coating machine.

According to a non-limiting embodiment, in the calculating, by the controller, of the average of the slurry application amount over the predetermined travel distance of the substrate by receiving the slurry application amount repeatedly measured from the measurement device, continuous measurement data of the slurry application amount repeatedly measured over the predetermined travel distance of the substrate may be organized into a certain group to calculate the average.

According to a non-limiting embodiment, the checking, by the controller, whether the calculated average of the slurry application amount is outside the specific management range, may further include displaying the specific management range on a screen, and visualizing the average of the slurry application amount calculated after receiving relevant data from the measurement device by displaying the average as continuous data over the specific management range displayed on the screen, wherein the specific management range may be one area including upper and the lower limits formed to maintain a center deviation within a range of ±0.05 mg/cm² to ±0.2 mg/cm².

The features and advantages of the present disclosure will become more apparent from the following detailed description based on the accompanying drawings.

The terms or words used in this specification and claims should not be construed in their usual, dictionary meaning, and should be interpreted with meaning and concept consistent with the technical idea of the present disclosure on the basis of the principle that the inventor can define terminology appropriately to explain his or her disclosure in the best way possible.

According to a non-limiting embodiment of the present disclosure, a slurry can be uniformly applied in the longitudinal direction to an electrode substrate.

According to a non-limiting embodiment of the present disclosure, control can be performed in a manner to converge the amount of slurry applied within a specified specific management range.

According to a non-limiting embodiment of the present disclosure, even if an operator incorrectly sets the initial conditions, the amount of slurry applied can be controlled uniformly.

According to a non-limiting embodiment of the present disclosure, the amount of slurry applied can be adjusted within a specific management range in response to changes in the slurry over time.

According to a non-limiting embodiment of the present disclosure, it is possible to manufacture high-quality secondary battery electrodes.

According to a non-limiting embodiment of the present disclosure, it is possible to prevent voltage imbalance between secondary batteries.

### BRIEF DESCRIPTION OF THE DRAWINGS

FIG. 1 is a view showing an apparatus for manufacturing an electrode of a secondary battery according to a non-limiting embodiment according to the principles of the present disclosure;

FIG. 2 is a view of a measurement device for measuring the amount of slurry applied to a substrate in an apparatus for manufacturing an electrode of a secondary battery according to a non-limiting embodiment according to the principles of the present disclosure;

FIG. 3 is a view showing a specific management range including an upper limit and a lower limit and control of the slurry application amount using the range in an apparatus for manufacturing an electrode of a secondary battery according to a non-limiting embodiment according to the principles of the present disclosure; and

FIG. 4 is a flowchart showing a method for manufacturing an electrode of a secondary battery according to a non-limiting embodiment according to the principles of the present disclosure.

### DETAILED DESCRIPTION

Hereinafter, the present disclosure will be described in detail (with reference to the attached drawings). However, this is only exemplary and the present disclosure is not limited to the specific embodiments described as exemplary.

The drawings may be schematic or exaggerated for the purpose of illustrating the embodiments.

In this document, expressions such as “have”, “may have”, “include”, or “may include” refer to the presence of the corresponding feature (e.g., a numerical value, function, operation, or component such as a part), and do not exclude the presence of additional features.

Hereinafter, a non-limiting embodiment of the present disclosure will be described in detail with reference to the attached drawings.

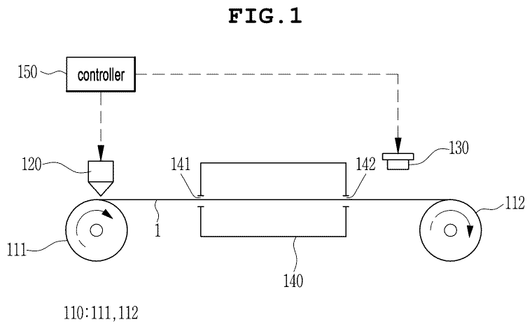

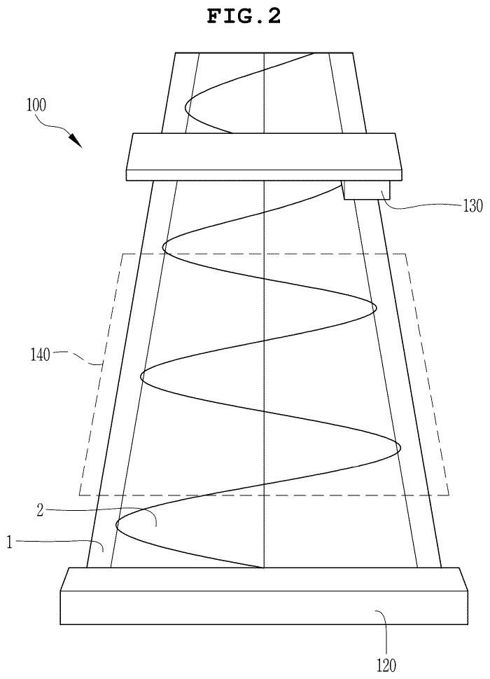

FIG. 1 is view showing an apparatus for manufacturing an electrode of a secondary battery according to a non-limiting embodiment, and FIG. 2 is a view of a measurement device for measuring the amount of slurry applied to a substrate in an apparatus for manufacturing an electrode of a secondary battery according to a non-limiting embodiment.

Referring to FIGS. 1 and 2, an apparatus 100 for manufacturing an electrode of a secondary battery according to the present disclosure may include: a conveyor 110 that transports a substrate 1 in the travel direction; a coating machine 120 that coats the substrate 1 transported in the travel direction by applying a slurry 2 onto the substrate 1; a measurement device 130 that repeatedly measures the slurry application amount while reciprocating in the width direction of the substrate 1 in a state where the substrate 1 is transported in the travel direction; and a controller 150 that receives the slurry application amount repeatedly measured from the measurement device 130, calculates an average of the slurry application amount for a predetermined travel distance of the substrate, and controls the coating machine to increase or decrease the slurry application amount within a predetermined control range if the calculated average is out of a specific management range.

The substrate 1 may be a metal foil for an electrode for a secondary battery. The substrate 1 may be a positive electrode substrate or a negative electrode substrate for a secondary battery. The metal foil may have a thin film structure. The metal foil may include at least one of copper (Cu), aluminum (Al), stainless steel, titanium (Ti), and nickel (Ni). In addition, the foil may include various materials such as metals having high conductivity. The substrate 1 may have a width of 600 mm to 1200 mm, but is not particularly limited thereto.

The slurry 2 may include an active material, a conductive material, and a binder. The active material may be a positive electrode active material or a negative electrode active material. The types of materials used for the conductive material and binder may vary depending on the type of the active material.

The conveyor 110 may be a roll-to-roll type. The conveyor 110 may transport the substrate 1 in a straight line by an unwinder 111 and a rewinder 112. The conveyor 110 may transport the substrate 1 at a travel speed of 0.5 to 1.5 m/sec or 30 to 100 m/min. The rewinder 112 may wind the substrate 1 coated with the slurry 2.

The coating machine 120 may coat one side or both sides of the substrate 1 by applying the slurry 2. The coating machine 120 may perform one-row or two-row coating on the substrate 1, and form a coating part on an electrode manufactured. The coating machine 120 may be a slot die coater. FIG. 2 shows an example in which two-row coating is performed.

The measurement device 130 may be any device capable of measuring the application amount of slurry 2 coated on the substrate 1 being transported at a predetermined travel speed. The measurement device 130 may be positioned in a direction perpendicular to the travel direction of the substrate 1. The reciprocating movement of the measurement device 130 in the width direction of the substrate 1 may be designated as one time, and the measurement device 130 may perform this reciprocating movement repeatedly to continuously obtain measurement data for several times. The measurement data means the slurry application amount.

The controller 150 may continuously receive measurement data, as feedback, from the measurement device 130 measured while the measurement device 130 repeatedly reciprocates in the width direction of the substrate 1, and may calculate an average of the slurry application amount on the basis of the measurement data. The average means a value obtained by dividing the sum of the slurry application amounts measured continuously several times by the number of measurement data used.

To calculate the average of the slurry application amount, the controller 150 may group and use the changes in the slurry application amount repeatedly measured while the measurement device 130 reciprocates in the width direction of the substrate 1. The controller 150 utilizes the measurement data of the slurry application amount repeatedly measured by the measurement device 130, but may perform grouping in a regularly determined form, such as the first group from the 1st to the Nth times, the second group from the 2nd to the N+1st times, the third group from the 3rd to the N+2nd times, etc. In this case, N may be a natural number greater than or equal to 2.

For example, the controller 150 may group the first to tenth measurement data in the order the data are received from the measurement device 130 that measures the slurry application amount coated on the substrate 1 through repeated reciprocating movements, and calculate an average. The controller 150 may organize the second to eleventh measurement data into another group and calculate an average, and may organize the third to twelfth measurement data into yet another group and calculate an average.

That is, the controller 150 performs grouping with a sequential arrangement by utilizing the measurement data received from the measurement device 130 as time series data arranged in time order, and may calculate an average by dividing the sum of the measurement data organized into a certain group by the number of measurement data used. The controller 150 may calculate the average continuously.

In addition, the controller 150 may determine whether the calculated average of slurry application amount is outside a specific management range, and when the calculated average is outside the specific management range, may control the slurry application amount by increasing or decreasing the amount so that the average converges within the specific management range. The specific management range may be located in one area and include an upper limit and a lower limit, and will be described in more detail below.

As shown in FIGS. 1 and 2, the apparatus 100 for manufacturing an electrode of a secondary battery according to the present disclosure may further include: a dryer 140 for drying the slurry 2 coated on the substrate 1. The controller 150 may group the changes in the slurry application amount, which is repeatedly measured by the measurement device 130 while the measurement device 130 reciprocates over a predetermined distance traveled by the substrate 1 from the point where the slurry 2 is applied to the substrate 1 by the coating machine 120 to a certain point where the substrate 1 passes through the dryer 140, and calculate the average.

As shown in FIG. 1, the dryer 140 may provide a space for drying the slurry 2 coated on the substrate 1, and may pass the substrate 1 through the interior thereof.

The dryer 140 may be provided as a chamber having a certain length, and may be modified such that the installation length of the chamber increases or decreases. The dryer 140 may be provided as a single unit chamber or in a form in which multiple unit chambers are connected.

The dryer 140 may include a heating unit using a hot air supply method, an induction heating method, or a mixed method thereof to dry the slurry 2 coated on the substrate 1.

The substrate 1 coated with the slurry 2 may be introduced into an inlet 141 of the dryer 140, passed through the interior, and then taken out through an outlet 142.

The measurement device 130 may be positioned in front of the outlet 142 of the dryer 140, and may repeatedly measure the slurry application amount while reciprocating in the width direction of the substrate 1 after the slurry 2 is applied to the substrate 1 being transported in the travel direction until drying is completed. The measurement device 130 may measure the application amount of slurry in a dried state for the slurry 2 that changes over time, and relay this measurement data to the controller 150 as feedback. For example, the time-dependent change in the slurry 2 may be a fine layer separation within a single slurry batch. The time-dependent change in the slurry 2 may be a difference in solids content between batches of slurry due to fine differences in material dispersion during the mixing process.

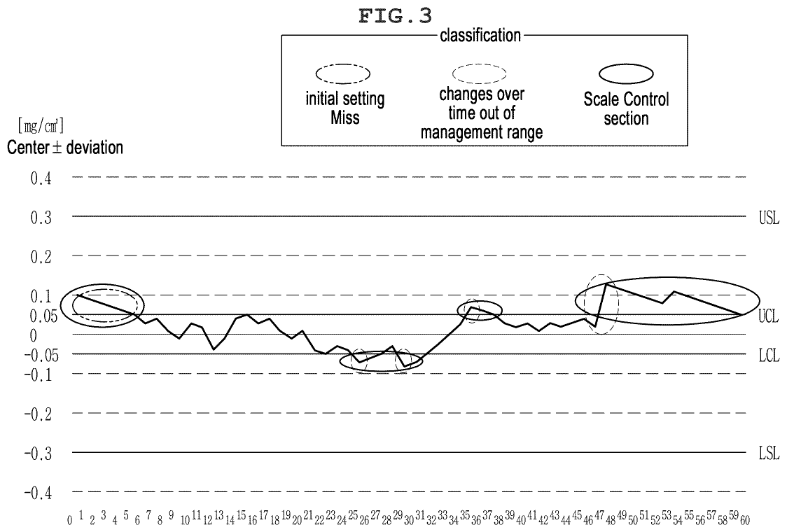

FIG. 3 is a view showing a specific management range including an upper limit and a lower limit and control of the slurry application amount using the range in the apparatus for manufacturing an electrode of a secondary battery according to a non-limiting embodiment.

Referring to FIG. 3, in the apparatus for manufacturing an electrode of a secondary battery according to the present disclosure, a specific management range may be one area set in the controller 150 and including an upper limit UCL and a lower limit LCL formed to maintain a center deviation within a range of ±0.05 mg/cm² to ±0.2 mg/cm². The upper limit UCL and the lower limit LCL may be absolute values having the same value. Although, in FIG. 3, only a center deviation of ±0.05 mg/cm² is shown for the specific management range, it should be clear that the present disclosure is not particularly limited by this example.

As shown in FIG. 3, in the specific management range, the upper limit UCL and the lower limit LCL may be designated as a range within a center deviation of ±0.3 mg/cm² for the highest upper limit USL and the lowest lower limit LSL, which are used as a good product range in the battery industry when controlling the amount of slurry 2 coated on the substrate 1. By designating a center deviation within the range of ±0.05 mg/cm² to ±0.2 mg/cm² for the upper limit UCL and the lower limit LCL of the specific management range, the risk of a large number of defects occurring when the change in the slurry 2 over time becomes rapid or when the initial conditions are set incorrectly due to operator error, etc., may be eliminated. When the center deviation is less than ±0.05 mg/cm² for the upper limit UCL and lower limit LCL of the specific management range, controlling the slurry application amount to converge within the range becomes difficult, and when the center deviation exceeds ±0.2 mg/cm², the good product range is easily gone beyond, which may result in mass production defects.

In the present disclosure, by designating the specific management range like the above, the average of the slurry application amount may be controlled in real time to converge within the upper limit UCL and lower limit LCL range that maintains the set center deviation. This can be called “scale control”.

Thus, in the present disclosure, since the application amount should be controlled to convergence only when the application amount exceeds the designated specific management range of the upper limit UCL and lower limit LCL on the basis of the average amount of slurry applied in the longitudinal direction of the substrate 1, the uniformity of the slurry application amount may be improved.

Referring to FIGS. 1 to 3, in the apparatus for manufacturing an electrode of a secondary battery according to the present disclosure, the controller 150 controls the coating machine 120 such that when the average of the slurry application amount calculated after receiving the relevant data from the measurement device 120 is outside the specific management range, the slurry application amount may be increased or decreased within a control range of a minimum of 0.005 mg/cm² to a maximum of 0.3 mg/cm².

The controller 150 may control the slurry application amount by increasing or decreasing the application amount by a certain amount, and may control the application amount to converge within the specific management range.

At this time, in controlling the slurry application amount, when the control range is set to less than the minimum value, fine control such as controlling the rotation speed of a slurry pump to output a slurry application amount less than the minimum value is impossible in controlling the coating machine 120 currently in use, whereas when the control range exceeds the maximum value, it becomes difficult to converge the application amount within the specific management range having the upper limit UCL and the lower limit LCL, and the coating of the slurry 2 may become too thick, resulting in mass production of defective products.

Referring to FIGS. 1 and 3, in the apparatus for manufacturing an electrode of a secondary battery according to the present disclosure, the controller 150 may display the specific management range as the upper limit UCL and the lower limit LCL on one area, and display the average of the slurry application amount calculated for a predetermined travel distance of the substrate after the relevant data is received from the measurement device 130 as continuous data together over the upper limit UCL and the lower limit LCL.

For this purpose, the controller 150 may include a display part including a screen.

The controller 150 displays the average of the slurry application amount calculated by receiving measurement data from the measurement device 130 on the screen, thereby enabling the coating state of the slurry 2 coated on the substrate 1 to be easily checked and monitored with the naked eye. In addition, it is easy to determine whether the slurry application amount is converging within the specific management range, and to check whether the control by means of the controller 150 is being properly performed.

As a result, according to the apparatus for manufacturing an electrode of a secondary battery of the present disclosure, the slurry 2 may be uniformly applied in the longitudinal direction of the substrate 1, and a high-quality electrode may be produced.

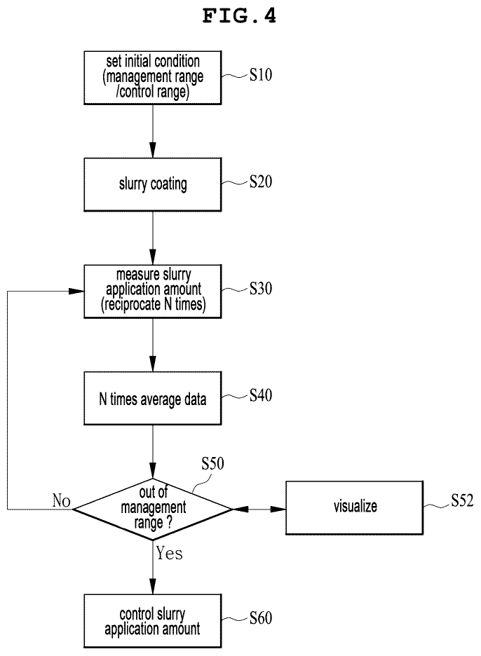

FIG. 4 is a flowchart showing a method for manufacturing an electrode of a secondary battery according to a non-limiting embodiment. To enhance understanding of the present disclosure, reference will be made to FIGS. 1 to 3 together.

Referring to FIGS. 1 to 4, a method for manufacturing an electrode of a secondary battery according to a non-limiting aspect of the present disclosure may include: coating (S20), by a coating machine 120, by applying a slurry 2 onto a substrate 1 being transported at a predetermined speed; repeatedly measuring (S30), by a measurement device 130, a slurry application amount while the measurement device 130 reciprocates in the width direction of the substrate 1 in a state where the substrate 1 is transported in the travel direction; calculating (S40), by a controller 150, the average of the slurry application amount over a predetermined travel distance of the substrate by receiving the slurry application amount repeatedly measured from the measurement device 130; checking (S50), by the controller 150, whether the average of the slurry application amount calculated is outside a specific management range; and controlling (S60), by the controller 150, the coating machine 120 to increase or decrease the slurry application amount when the average of the slurry application amount is outside the specific management range.

In the step of coating (S20) the substrate 1, by the coating machine 120, by applying the slurry 2 onto the substrate 1 being transported at a predetermined speed, the substrate 1 may be transported at a travel speed of 0.5 to 1.5 m/sec or 30 to 100 m/min.

In the step of repeatedly measuring (S30), by the measurement device 130, the slurry application amount while the measurement device 130 reciprocates in the width direction of the substrate 1 in a state where the substrate 1 is transported in the travel direction, the measurement device 130 may be moved back and forth and repeatedly in the width direction of the substrate 1. The controller 150 may control the measurement device 130 so that when one reciprocating movement is counted as one time, it takes about 5 to 10 seconds per time.

In addition, in the step of repeatedly measuring (S30), by the measurement device 130, the slurry application amount while the measurement device 130 reciprocates in the width direction of the substrate 1 in a state where the substrate 1 is transported in the travel direction, with the measurement device 130 positioned in front of an outlet 142 of a dryer 140, the slurry application amount may be repeatedly measured over a predetermined travel distance of the substrate 1 until a certain point at which the substrate 1 passes through the dryer 140 after the slurry 2 is applied to the substrate 1 by the coating machine 120.

The measurement device 130 may measure the application amount of slurry in a dried state for the slurry 2 that changes over time, and relay this measurement data to the controller 150 as feedback. The time-dependent change in the slurry 2 may be a fine layer separation within a single slurry batch. The time-dependent change in the slurry 2 may be a difference in solids content between batches of slurry due to fine differences in material dispersion during the mixing process.

In the step of calculating (S40), by the controller 150, the average of the slurry application amount over a predetermined travel distance of the substrate 1 by receiving the slurry application amount repeatedly measured from the measurement device 130, the continuous measurement data of the slurry application amount repeatedly measured over a predetermined travel distance of the substrate 1 may be organized into a certain group and an average may be calculated. The average means a value obtained by dividing the sum of the slurry application amounts measured continuously several times by the number of measurement data used, and may be calculated continuously.

In the step of calculating, by the controller 150, the average of the slurry application amount over a predetermined travel distance of the substrate 1 by receiving the slurry application amount repeatedly measured from the measurement device 130, from the continuous measurement data of the slurry application amount repeatedly measured from the measurement device 130, an average for individual group based on the measurement data, such as the first group from the 1st to the Nth times, the second group from the 2nd to the N+1st times, the third group from the 3rd to the N+2nd times, etc., may be continuously calculated.

At this time, the controller 150 calculates an average by utilizing measurement data of the slurry application amount repeatedly measured by the measurement device 130. That is, the controller 150 performs grouping in a regularly determined form, such as the first group from the 1st to the Nth times, the second group from the 2nd to the N+1st times, the third group from the 3rd to the N+2nd times, etc., and then calculates an average by dividing the sum of the measurement data of each group by the number of measurement data used. In this case, N may be a natural number greater than or equal to 2.

The controller 150 may continuously calculate an average using the time-series order of the measurement data.

In the present disclosure, due to the arrangement and averaging using the time-series order of the measurement data, the state of the amount of slurry applied in the longitudinal direction of the substrate 1 may be checked more easily and accurately, and the continuously calculated average may be utilized for feedback control.

In the step of checking (S50), by the controller 150, whether the average of the slurry application amount calculated is outside a specific management range, a range is set in which an upper limit UCL and a lower limit LCL are designated on one area, and it can be checked whether the continuously calculated average of slurry application amount is within the range of the designated upper limit UCL and lower limit LCL or out of the designated range.

In the step of checking (S50), by the controller 150, whether the average of the slurry application amount calculated is outside a specific management range, when the average of slurry application amount is outside the specific management range, the controller 150 may perform the step of controlling (S60) the coating machine 120 to increase or decrease the slurry application amount.

In the step of controlling (S60), by the controller 150, the coating machine 120 to increase or decrease the slurry application amount when the average of the slurry application amount is outside the specific management range, the controller 150 may control the slurry application amount so that the average of the slurry application amount converges within the upper and lower limits of the specific management range.

When the average of slurry application amount is found to not fall outside the specific management range in the step of checking (S50), by the controller 150, whether the average of the slurry application amount calculated is outside a specific management range, feedback may be given to return to the step (S30) in which the slurry application amount coated on the substrate 1 is repeatedly measured by the measurement device 130 while the measurement device 130 reciprocates over a predetermined travel distance of the substrate 1. In other words, the process may be repeated.

In addition, the method for manufacturing an electrode of a secondary battery according to a non-limiting aspect of the present disclosure may further include setting (S10), in the controller 150, a specific management range that serves as a standard for controlling the amount of slurry applied to the substrate 1, and a predetermined control range for controlling the slurry application amount when the slurry application amount exceeds the specific management range before the step of coating (S20) the substrate 1 by applying the slurry 2 onto the substrate 1.

The step of setting (S10) a specific management range and a predetermined control range is a step that enables range control, that is, scale control, by using a convergence method for the amount of slurry applied in the longitudinal direction of the substrate 1.

The specific management range is a range where an upper limit UCL and a lower limit LCL are designated in one area, the upper limit UCL and the lower limit LCL are set to form a center deviation within the range of ±0.05 mg/cm² to ±0.2 mg/cm², and the predetermined control range may be set to control the slurry application amount within a range of a minimum of 0.005 mg/cm² to a maximum of 0.3 mg/cm². Although only a center deviation of ±0.05 mg/cm² is shown for the specific management range in FIG. 3, the present disclosure is not particularly limited thereto.

Thus, in the step of controlling (S60), by the controller 150, the coating machine 120 to increase or decrease the slurry application amount, the slurry application amount may be controlled by increasing or decreasing the slurry application amount within a control range of a minimum of 0.005 mg/cm² to a maximum of 0.3 mg/cm² so that the average of slurry application amount converges within a specific management range. For example, the controller 150 may control the coating machine 120 to increase or decrease the slurry application amount by a constant amount corresponding to 0.01 mg/cm², and due to this, the amount of slurry applied in the longitudinal direction of the substrate 1 may be controlled to converge within the specific management range. The coating machine 120 may control the slurry application amount by controlling the rotation speed of a slurry pump.

In addition, the step of checking (S50), by the controller 150, whether the average of the slurry application amount is outside a specific management range may further include a step of displaying (S52) the specific management range on the screen, and visualizing the average of the slurry application amount calculated after receiving relevant data from the measurement device 130 by displaying the average as continuous data over the specific management range displayed on the screen. The specific management range may be one area including the upper limit UCL and the lower limit LCL formed to maintain a center deviation within a range of ±0.05 mg/cm² to ±0.2 mg/cm².

In conclusion, according to the method for manufacturing an electrode of a secondary battery of the present disclosure, the slurry 2 may be uniformly applied in the longitudinal direction of the substrate 1, and a high-quality electrode may be manufactured. Furthermore, since an electrode is provided in which the slurry 2 is uniformly applied in the longitudinal direction of the substrate 1, voltage imbalance between secondary batteries may be prevented.

Above, the present disclosure has been described in detail through specific embodiments. The embodiments are for specifically explaining the present disclosure, and are only illustrative and do not limit the scope of the appended claims. It is obvious to those skilled in the art that various changes and modifications to the embodiments are possible within the scope and technical idea of the present disclosure, and it is natural that such changes and modifications fall within the scope of the appended claims.

1. An apparatus for manufacturing an electrode of a secondary battery, the apparatus comprising:
a conveyor configured to transport a substrate in a travel direction;
a coating machine configured to coat the substrate transported in the travel direction by applying a slurry onto the substrate;
a measurement device configured to repeatedly measure a slurry application amount while reciprocating in a width direction of the substrate in a state where the substrate is transported in the travel direction; and
a controller configured to receive the slurry application amount repeatedly measured from the measurement device, calculate an average of the slurry application amount for a predetermined travel distance of the substrate, and control the coating machine to increase or decrease the slurry application amount within a predetermined control range when the calculated average is outside a specific management range.

2. The apparatus of claim 1,
wherein the specific management range is set in the controller and is one area comprising an upper limit and a lower limit formed to maintain a center deviation within a range of ±0.05 mg/cm² to ±0.2 mg/cm².

3. The apparatus of claim 1,
wherein the controller controls the coating machine, and when the average of the slurry application amount is outside the specific management range, increases or decreases the slurry application amount within a control range of a minimum of 0.005 mg/cm² to a maximum of 0.3 mg/cm².

4. The apparatus of claim 1, further comprising:
a dryer configured to dry the slurry coated on the substrate,
wherein the controller organizes changes in the slurry application amount into a certain group, which is repeatedly measured by the measurement device while the measurement device reciprocates over the predetermined travel distance of the substrate from a point where the slurry is applied to the substrate by the coating machine to a point where the substrate passes through the dryer, and calculates the average.

5-12. (canceled)

13. The apparatus of claim 1,
wherein the controller is configured to display a specific management range as an upper limit and a lower limit on one area, and is configured to display, on the area having the upper and lower limits, continuous data representing an average of the slurry application amount calculated over a predetermined travel distance of the substrate after receiving the slurry application amount from the measurement device.

14. The apparatus of claim 4,
wherein the measurement device is configured to be disposed in front of an outlet direction of the dryer and to repeatedly measure a slurry application amount for a predetermined travel distance of the substrate from a point where the slurry is applied onto the substrate by the coating machine to a point where the substrate passes through the dryer.

15. The apparatus of claim 1,
wherein the controller is configured to perform grouping with a sequential arrangement by utilizing the slurry application amounts received from the measurement device as time-series data in accordance with a temporal flow, and is configured to calculate an average by dividing a sum of the slurry application amounts forming a group generated through the grouping by the number of measurement data used.

16. The apparatus of claim 15,
wherein the controller is configured to determine whether a calculated average of the slurry application amount is outside a specific management range, and, when the calculated average is outside the specific management range, is configured to control the slurry application amount by increasing or decreasing the amount so that the average converges within the specific management range.

17. The apparatus of claim 15,
wherein the controller is configured to continuously calculate an average by utilizing slurry application amounts received from the measurement device as time-series data in accordance with a temporal flow, and to use the continuously calculated average for feedback control to manage the slurry application amount.

18. The apparatus of claim 13,
wherein the controller includes a display part configured to display the specific management range on a screen, and visualize the average of the slurry application amount, which is calculated after being received from the measurement device, by displaying the average as continuous data over the specific management range displayed on the screen.
